(19) United States
(12) Patent Application Publication
(10) Pub. No.: US 2017/0351977 A1
(43) Pub. Date: Dec. 7, 2017

(54) FACILITATING USER ACTION BASED ON TRANSMISSIONS OF DATA TO MOBILE DEVICES

(71) Applicant: Uber Technologies, Inc., San Francisco, CA (US)

(72) Inventor: Rahul Bijor, San Francisco, CA (US)

(21) Appl. No.: 15/599,312

(22) Filed: May 18, 2017

Related U.S. Application Data
(60) Provisional application No. 62/346,811, filed on Jun. 7, 2016.

(51) Int. Cl. G06Q 10/02; G06F 17/30; H04W 4/02; H04L 29/08; G06Q 50/30

(52) U.S. Cl. CPC G06Q 10/02; H04W 4/021; H04L 67/327; G06F 17/30867; H04L 67/306; G06Q 50/30

(57) ABSTRACT

A system to facilitate user action is disclosed. The system receives a first set of data indicating a request and an event identifier from an event provider device, and generates and transmits a first notification based, at least in part, on the first set of data to a set of identified users. The system can receive an acceptance from a user device of a first user of the set of identified users, send a second notification to the provider device, and subsequently coordinate a transport service for the first user.

### RELATED APPLICATIONS

This application claims benefit of priority to Provisional U.S. Patent Application No. 62/346,811, filed Jun. 7, 2016; the aforementioned priority application being incorporated by reference in its entirety.

### BACKGROUND

A network system can provide a network service in which users can request particular services. In some instances, for example, other parties may want to leverage the network system to share data with users and/or service providers that use the network service.

### BRIEF DESCRIPTION OF THE DRAWINGS

FIG. 1A illustrates an example network system, as described herein.

FIG. 1B illustrates components of an example network system of FIG. 1A.

FIG. 2A illustrates an example method for facilitating user participation in events.

FIG. 2B illustrates an example method for providing a service notification.

FIG. 3 illustrates an example method of selectively performing operations for users of an event.

FIG. 4A illustrates an example user interface of an event provider dashboard that is accessible by the event provider via an event provider portal on an event provider device.

FIG. 4B illustrates an example user interface of an event provider dashboard that includes map content.

FIG. 5 is a block diagram that illustrates a computing device upon which embodiments described herein may be implemented.

FIG. 6 is a block diagram that illustrates a computer system upon which examples described herein may be implemented.

### DETAILED DESCRIPTION

Examples described herein provide a system to enable event providers or planners (e.g., individuals, groups, companies, etc.) to dynamically facilitate the fulfillment of open or available seats at their events. In some examples, a particular event may have a surplus of available seats that are unclaimed or unpurchased. According to examples herein, the system can provide a network service in which an event provider can access a provider user interface on a computing device in order to notify a set of users about the availability of seats at a particular event. One or more users of the network service can view the notification and have the option of accepting or reserving one or more seats for the event through use of their computing devices.

In some examples, the system can correspond to a service arrangement system. The system can receive requests for services from users of the service arrangement system (e.g., delivery services, transport services, etc.) and select service providers (e.g., drivers) to perform or provide the services. The service arrangement system can also provide a portal to enable event providers to communicate information about events with available seats to users of the service arrangement system. In some examples, the system can receive a first set of data (e.g., a first in-app notification, message, etc.) indicating a request to send a notification associated with an event from an event provider computing device operated by an event provider. In some implementations, the first notification can include an identifier associated with the event (and/or an identifier associated with the provider), availability information of one or more available seats for the event, and/or data associated with a start time of the event. The system can identify a set of users that are to receive a notification associated with the event. Depending on variations, the system can identify the set of users based on one or more parameters or criteria.

The system can generate a notification based, at least in part, on the first notification. For example, the notification can include content about the event, the start time, a number of available seats (and/or details about available seats), a price for the available seat(s), a price discount or offer provided by the event provider, a time limit for accepting or requesting an available seat(s), and/or other information. The system can transmit the notification to the identified users' computing devices. Subsequently, a user may accept or reserve one or more seats by interacting with a user interface on the user's respective computing device. In some examples, the system can receive a notification indicating an acceptance or the user's interest in attending the event and a number of the requested seats (and/or which particular seats, in some examples) specified by the user. The system can process the acceptance notification and transmit a second set of data (e.g., a second in-app notification, message, etc.) to the event provider. The second set of data can include an identifier of the user and the number of the requested seats (and/or which particular seats, in some examples).

In one example, a user(s) of the system can indicate, by providing input on a user interface, a specific event category(s) or type(s) of events that he/she is interested in receiving information about via the system. The system can store event preference information in the user profile or record. Depending on implementation, an event category can correspond to a musical concert, a film, a play or musical show, a sporting event, a social event (e.g., party, museum event), a pop-up store event, a hotel reservation, a flight reservation, or a restaurant reservation, in some examples. The user can also specify interest in sub-categories for one or more event categories, such as type of music, types of films, types of plays or musical shows, types of sports or teams, types of social events or parties, areas of interest for visiting, types of food, etc. Still further, in some examples, the system can also provide an application user interface (e.g., an in-app feature or interface) to enable users to browse or search for (and/or select) any open or upcoming events with excess inventory or availability.

According to some examples, the system can also arrange a transport service for the user based, at least in part, on a set of travel parameters. The set of travel parameters can include a destination location that corresponds to a location of the event (or is within a specified distance from the location of the event). In some examples, the system can determine when to notify the user to request a transport service based, at least in part, on the location of the event and/or the start time of the event.

Among other benefits, examples described herein achieve a technical effect of improving the fulfillment of available seats at events by allowing event providers to dynamically provide event information to user devices, even at a short amount of time before the start time of an event. Other technical effects include reducing the number of ineffective notifications or messages sent to user devices by identifying only certain users or groups of users to receive the event information based on the current or up-to-date event information. Still further, in some examples, user interfaces or graphic dashboards enable event providers to view information and/or perform operations in connection with specified users that are participating in the events in real-time (or close to real-time).

As used herein, a client device, a computing device, and/or a mobile computing device refer to devices corresponding to desktop computers, cellular devices or smartphones, personal digital assistants (PDAs), laptop computers, tablet devices, etc., that can provide network connectivity and processing resources for communicating with a remote computing system(s) over one or more networks, such as a service arrangement system. A remote computing system can refer to one or more computing systems or servers that are remote from the client device or the mobile computing device (e.g., corresponds to the back-end server system of the network service).

Still further, examples described herein relate to a variety of location-based (and/or on-demand) services, such as a transport service, a delivery service, etc. to be arranged between users/requesters/riders and service providers/service providers. In some examples, a service arrangement system can be implemented by any entity that provides transport or delivery services to be requested by users, and/or provides goods or services for purchase through the use of computing devices and network(s). For purpose of simplicity, in examples described herein, the service arrangement system can correspond to a transport arrangement system that arranges transport services to be provided for riders/users by vehicles (e.g., transporting objects or people) and/or an event facilitation system that enables users to reserve seats at specified events.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described herein can be carried and/or executed. In particular, the numerous machines shown with examples described herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

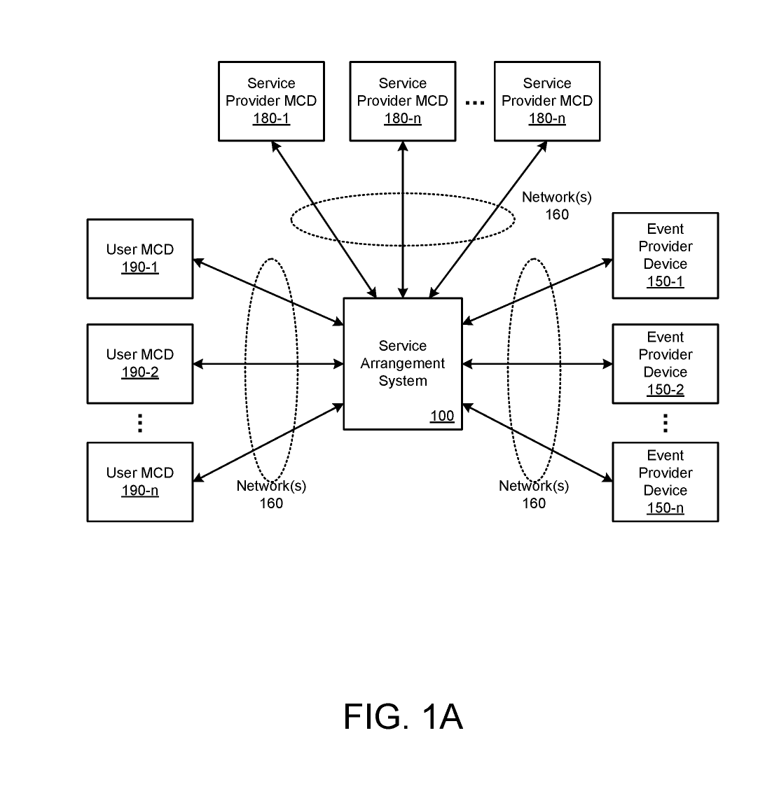

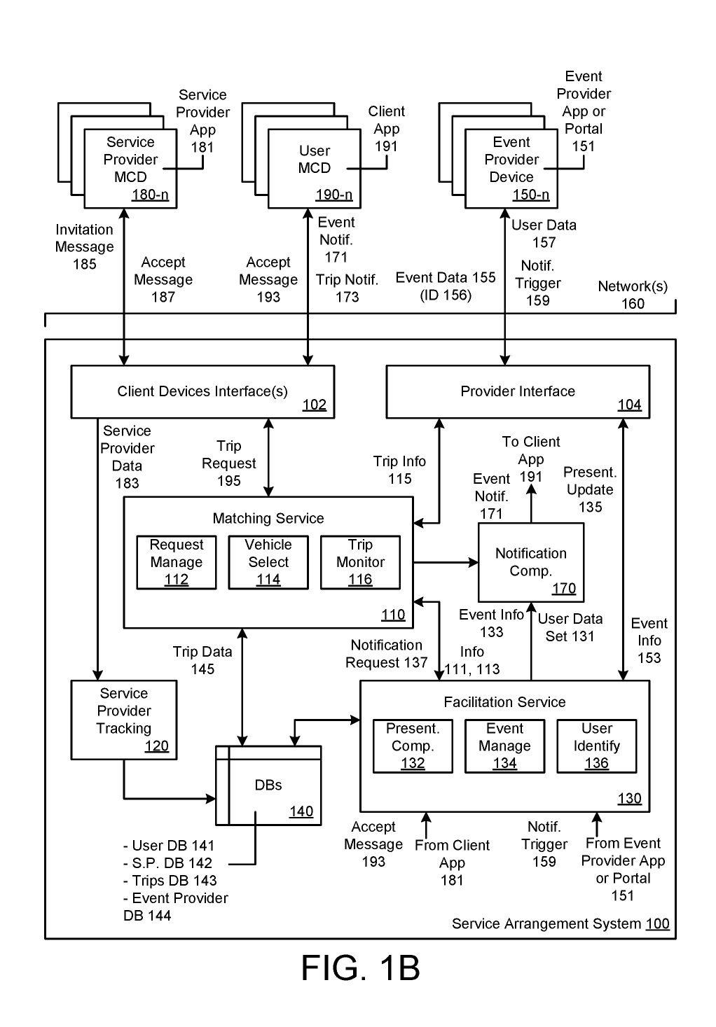

FIG. 1A illustrates an example network system, as described herein. The service arrangement system 100 can correspond to a set of computing systems (e.g., computing devices, servers, data centers, etc.) that implement a network service. In examples described herein, the service arrangement system 100 can arrange transport services to be provided by service providers for requesting users. The service arrangement system 100 can communicate with a plurality of user mobile computing devices (MCDs) 190 operated by requesters or users of the network service and a plurality of service provider MCDs 180 operated by service providers or drivers. Individual MCDs 180, 190 can store and run a designated client service application (service provider application or user application, respectively) that communicates with the service arrangement system 100 over one or more network(s) 160. A user can operate the user application to make a request for a service, such as a transport service or a delivery service, and a service provider can operate the service provider application to receive invitations for providing the service for the user.

A user can operate a MCD (e.g., MCD 190-1), to communicate with the service arrangement system 100 over a network(s) 160 (e.g., a wireless networks, a cellular network, etc.) to request a transport service. The user can launch or open the designated user application, which communicates with the service arrangement system 100 to receive information about the transport service in real-time or close to real-time (e.g., the estimated location of vehicles, the estimated time of arrival to the user's current location or a user-specified pickup location). Additionally, by interacting with the designated client service application, the user can specify the pickup location, the destination location, and/or the vehicle type, and make a request for a transport service. Based on one or more of the user-specified transport parameters, the service arrangement system 100 can receive the request and programmatically select a service provider or driver to provide the transport service. Additionally, in some implementations, the service arrangement system 100 can transmit an invitation message to the selected service provider's MCD (e.g., MCD 180-1), to travel to the pickup location and provide the transport service for the user.

The service arrangement system 100 can also communicate (e.g., exchange data) with a plurality of event provider devices 150 over one or more network(s) 160. Additionally, individual event provider devices 150 can store and run a designated event provider application or can run a browser that displays web content (e.g., as a web portal) provided by the service arrangement system 100. In some examples, the service arrangement system 100 can enable event providers to generate notifications about the availability of one or more seats at events operated or provided by the event provider. In some implementations, the service arrangement system 100 can enable the event providers to interact with the event provider application or the web content to generate the notifications. The service arrangement system 100 can perform operations to facilitate user participation in events in conjunction with arranging transport services.

Service Arrangement System

FIG. 1B illustrates components of an example network systemof FIG. 1A, according to some examples. For example, the service arrangement system 100, which is also referred to herein as the system 100, can include a client device interface 102, an event provider interface 104, a matching service 110, a service provider tracking component 120, an event facilitation service 130, one or more databases 140, and a notification component 170. For purpose of simplicity, other components of the system 100, such as a user interface component, other databases, etc., are not illustrated in FIG. 1B. The system 100 can be implemented on network side resources, such as on one or more servers or data centers, or implemented through other computer systems in alternative architectures (e.g., peer-to-peer network(s) 160, etc.).

In some examples, the client device interface 102 enables the system 100 to exchange data between the system 100 and each of the MCDs 180, 190 operated by users and service providers/drivers via the respective designated client service applications 181, 191. While examples herein describe the client application 191 as being a designated application for requesting services, such as transport or delivery services (e.g., goods or food delivery), in other examples, the client application 191 can correspond to a different standalone application that is offered by the entity operating the system 100. The provider interface 104 enables the system 100 to exchange data between the system 100 and the event provider application or event portal 151 (referred to herein as an “event provider portal 151”) via the respective event provider devices 150. The client device interface 102 and the provider interface 104 can use one or more network resources (e.g., network(s) 160) of the system 100 to exchange communications over one or more wireless networks (e.g., a cellular transceiver, a WLAN transceiver, etc.). In some examples, the client device interface 102 and/or the provider interface 104 can include or use an application programming interface (API), such as an externally facing API, to communicate data with the respective systems. The externally facing API can provide access to the event provider devices 150 and/or the MCDs 180, 190 via secure access channels over the network 160 through any number of methods, such as web-based forms, programmatic access via RESTful APIs, Simple Object Access Protocol (SOAP), remote procedure call (RPC), scripting access, etc.

According to some examples, the facilitation service 130 can include a presentation component 132 that generates a user interface(s) to be displayed by the event provider portal 151 on one or more event provider devices 150. An event provider operating an event provider device 150 can sign in (using the provider's credentials, e.g., user name, identifier, email, and/or password, etc.) to the network service via the event provider portal 151 (e.g., by operating an application or interacting with a web browser, etc.) and can view information associated with the event provider's account. In some examples, the event provider can interact with the user interface of the event provider portal 151 to create, view, delete, and/or modify one or more event entries each associated with an event that the event provider operates or provides. For example, the event provider can be a restauranteur (e.g., an owner or manager of a restaurant) and an event can correspond to a reservation for a specified starting time at the restaurant. In other examples, the event provider can be a venue owner or operator (e.g., a sports team, an operator of an event space, a movie theater, etc.) or an entertainer or manager for an entertainer (e.g., a musician, a band, a standup comedian, etc.), and the event can correspond to a respective show or sporting event. Still further, in yet other examples, the event provider can be a host of a party or event planner, or an individual hosting a private party or pop-up event.

The event provider can create entries for events that the event provider is hosting or organizing by providing input on a user interface of the event provider portal 151. For example, the user interface can include selectable features, drop down options, and/or text fields that the event provider can interact with in order to input specified event information 153 for each event. The event manage component 134 of the facilitation service 130 can receive the event information 153 and can generate an event entry or record with the specified event information 153, for example, to be stored in a database 140 of the system 100. In some implementations, an event entry can be associated with the event provider and can include (i) an event identifier, (ii) an event type identifier, (iii) location information for the event, (iv) a date, (v) a start time and/or event duration information, (vi) number of total seats, (vii) a number of available seats, (viii) seat information, in some instances, (ix) content corresponding to a description of the event, (x) price information for the seat(s) and/or the event, and/or (xi) other event information. Event entries for an event provider can be stored in an events database (not illustrated in FIG. 1B) and/or can be stored or associated with an event provider account in the event provider database 144.

In some examples, the event provider portal 151 can interface with, via an API(s) or a plug-in(s), a reservation or inventory service used by the event provider. The reservation or inventory service can provide event information 153 to the event provider portal 151 and/or the facilitation service 130 so that event entries can be updated with corresponding data from the reservation or inventory service. In such examples, updates or changes to the events in the reservation or inventory service of the event provider can automatically cause updates or changes to the event entries of the event provider in the system 100.

In many instances, a particular event (e.g., a 6:30 pm restaurant reservation) may not be entirely full or reserved, such that one or more seats at the event are available to be requested or reserved by an individual. According to some examples, at a time before the start time of the event (e.g., a few hours before or even a few minutes before 6:30 pm), the event provider can access the event provider portal 151 to have the system 100 send a notification about the availability of the event to a set of users. For example, a user interface of the event provider portal 151 may present information about each event associated with the event provider. Additionally, the event provider can interact with the user interface to select an event(s) and/or specify the number of available seats for the event(s) that the event provider wants to make known to users of the system 100. In other examples, the event provider can simply request a notification about an available event to be sent by the system 100. Additionally, the system 100 can determine, from the corresponding event entry, the number of available seats. In yet other examples, the event provider can also specify or select an individual user and/or a group(s) of users to share information about the event.

The event provider device 150 can transmit a set of event data 155 to the facilitation service 130 via the one or more network(s) 160, when the event provider makes the request to send a notification to users of the system 100. In some examples, the set of event data 155 can indicate that the event provider wants the system 100 to notify a set of users about a particular event organized or operated by the event provider and can include an identifier (ID) 156 of the event and/or an ID of the event provider. In some implementations, the set of event data 155 can also include other information, such as availability information of the number of available seats for the event or availability information of the number of available seats that the event provider wants to share with the set of users. For example, there may be ten available seats for the 6:30 pm reservation slot, but the event provider may want to fill only six of the available seats through use of the system 100. Still further, in other examples, the set of event data 155 can also include data associated with a price for the available seat(s) or the event and/or data associated with a price amount or price discount to encourage users to accept or reserve an available seat at the respective event. The price discount can correspond to an amount to be paid for by the event provider for the seat(s) itself, for example, or for the transport service that can be provided for the user through the network service.

When the facilitation service 130 receives the event data 155, the event manage component 134 can access the events database or the event provider database 144 to determine the corresponding event entry based on the ID 156 of the event (and/or the ID of the event provider) and also identify the event provider. The event entry of the event can include the respective event information 153 specific to the event, e.g., the name of the event, the start date and start time, the location of the event or event venue, the number of available seats at the event, etc. As an addition or an alternative, in some instances, an event provider can create a new event entry as part of the request to send a notification to users of the system 100. For example, when the event provider wants to send a notification about the availability of an event to a set of users, the event provider can select a feature, such as “send notification” and subsequently specify the event information 153. Once the relevant event information 153 is inputted and the event provider submits the request, the event provider portal 151 can transmit the set of event data 155 along with the event information 153 to the facilitation service 130. The event manage component 134 can then create an event entry for the event and assign an ID 156 for the event entry.

A user identify component 136 of the facilitation service 130 can determine which users are to receive a notification about the event. In examples described herein, the system 100 can provide a network service in which users can make requests for transport or delivery services (also referred to herein as a trip) using their respective client applications 191. Additionally, the system 100 can select service providers send invitation messages to the selected service providers, to provide the transport or delivery services requested by the users. An event provider can leverage the system 100 to notify a set of users (and/or a set of service providers) about an available event from a pool of users (and/or a pool of service providers) that each have an existing account or profile stored with the system 100 (e.g., stored in a user database 141 and/or a service provider database 142). In such examples, the pool of users and/or the pool of service providers can correspond to those individuals who have already registered or signed up to use the network service provided by the system 100 and who have opted in to receive notifications or offers about events from event providers. The user identify component 136 can access the user database 141 and/or the service provider database 142 to determine a set of individuals to send an event notification to in order to provide those individuals with an opportunity to reserve or accept an available seat at the event.

In some examples, the event provider can request the system 100 to notify a specified set of users. In such examples, the event provider can access the contacts (or friends list) or mailing list of the event provider via the event provider portal 151 or the event provider's inventory service and select individual users (e.g., those users who have shared their contact information with the event provider). The set of event data 155 can then include a set of user identifiers (e.g., user names, phone numbers, email addresses, etc.) specified by the event provider. The user identify component 136 can search the user database 141 to identify the profiles of users profiles from the set of user identifiers. In some examples, the user identify component 136 can determine whether those users have opted in to receive notifications. Additionally, in such examples, the user identify component 136 can enable the system 100 to transmit an event notification to those users' mobile computing devices 190. In some implementations, the user identify component 136 can use the user identifiers to enable the system 100 to transmit a notification to the respective devices of the set of users using one or more communication protocols (e.g., a text message, an email, etc.), in examples where the specified users are not users of the system 100.

In other examples, the event provider can request the system 100 to notify a set of users about an event without selecting or specifying which users or groups of users are to receive the event notification. In such examples, the user identify component 136 can determine the set of users that should be targeted to receive the event notification by (i) determining a geographic region based on the location of the event or the event venue (e.g., an address of the restaurant or the concert hall, etc.), or alternatively, based on the event provider's identifier from the set of event data 155, and (ii) determining the set of users based, at least in part, on the geographic region. For example, the geographic region can be computed using a predetermined radius or distance from the location of the event or can correspond to a predetermined geofence (e.g., defined by three or more location data points) that includes the location of the event. In some implementations, the geographic region can correspond to predetermined neighborhood border, city limit, county limit, etc. Based on the geographic region (or alternatively, based on the location of the event and a distance from the location of the event) and/or based on other event information 153 (such as a type of event or start time of the event), the user identify component 136 can search the user database 142 (and/or the associated trips of those users in the trips database 143) to identify a set of users that should receive the notification about the specific event.

The user identify component 136 can determine the set of users using data from one or more different sources of data. Examples of sources of data include, user accounts or profiles in the user database 141 or trip entries in the trips database 143, etc. In some examples, the system 100 can aggregate a variety of data, such as data obtained based on user action on the respective client applications 191, current or close to real-time data, and/or historical data. For example, the user identify component 136 can determine the set of users that (i) indicated or associated, in their respective profiles in the user database 141, one or more user-specific locations associated with the respective user (e.g., a home address or work address) that are within the geographic region, (ii) have recently completed a transport service starting at a location and/or ending at a location within the geographic region within a last predefined duration of time (e.g., within the last twelve hours, or within the last three days, etc.), (iii) have inputted, in their respective client application 191, the starting location and/or destination location at the event venue or location, (iv) have recently opened their respective client application 191 at a location within the geographic region within a last predefined duration of time, (v) are currently located within the geographic region (e.g., those users who have opted in to allow their current locations to be known by the user mobile computing device 190 and/or the client application 191), and/or (vi) have profiles indicating one or more interests that match or correspond to the type of event. Still further, in some examples, the user identify component 136 can determine a score for individual users by applying scoring weights or values to at least some of the different factors described above, and by selecting a set of users having the highest scores. Alternatively, the user identify component 136 can select a set of users that have a score greater than or equal to a threshold score.

In some implementations, the user identify component 136 can also filter out certain users from receiving an event notification based on the start time and location of the event, thereby reducing the number of excessive and potentially ineffective event notifications. For example, in some instances, the event provider may make a request to the system 100 to send a notification about an event just a short time before the start of the event, such as thirty minutes beforehand (e.g., as a result of a last minute cancellation or additional seating being available). In examples where the user identify component 136 determines a group of users based on the recent user location for individual users in a geographic region (e.g., the recent drop off locations of users, the current locations of users, and/or recently stored locations of users in the past predefined duration of time), the user identify component 136 can further compute, for each user in the group, an estimated distance and/or travel time away from the recent user location to the event location. In some implementations, the user identify component 136 can communicate with a routing engine and/or a map service to determine the estimated travel time of each user to the event location. Additionally, the user identify component 136 can communicate with the routing engine and/or map service to compare the determined estimated travel time with an amount of time left between the current time and the start time of the event. In other implementations, the user identify component 136 can communicate with the routing engine or map service to compare the estimated travel time with an amount of time left between the time when the set of event data 155 was first received from the event provider and the start time of the event.

Based on the determined amount of time, the user identify component 136 can then filter out those users from the group of users to reduce the number of ineffective notifications or messages sent to user MCDs 190. For example, the user identify component 136 can filter out users from the group of users that have an estimated travel time that is (i) equal to or greater than the determined amount of time (e.g., thirty minutes), or (ii) equal to or greater than the determined amount of time left less a predefined duration of time (e.g., thirty minutes minus five minutes, so twenty five minutes), to provide some additional leeway of a user accepting the event offer and/or to account for potential communication delays as a result of network conditions or bandwidth restrictions. According to some examples, by filtering out certain users from the group of users, the system 100 can reduce the number of ineffective notifications or messages sent to user MCDs 190, thereby reducing the total amount of data transmitted to user MCDs 190 (as compared to transmitting messages to a larger set of users without the filtering).

The facilitation service 130 can communicate with the notification component 170 to cause the notification component 170 to generate and transmit an event notification 171 about the event to the identified set of users' MCDs 190. In some implementations, the notification component 170 can be a part of the facilitation service 130 or can be component accessible by services of the system 100 (e.g., accessible by both the matching service 110 and the facilitation service 130, such as illustrated in FIG. 1B). The facilitation service 130 can instruct the notification component 170 to generate and transmit an event notification 171 by providing a set of event information 133 (determined from the event entry) and data about the identified set of users that are to receive the event notification (e.g., user data set 131) to the notification component 170. In some examples, the event entry can include up-to-date information of the number of available seats, if any, as a result of the event provider updating the number of available seats as individuals reserve or cancel seats or as individuals buy tickets, or in response to updates to the event provider's reservation or inventory service. According to examples, the set of event information 133 can include (i) a name of the event and/or the event provider, (ii) location information for the event, (iii) a start time of the event, (iv) availability information for the event (e.g., number of available seat(s), specific available seat(s), etc.), (v) price information for the available seat(s), (vi) price discount for the event or for the transport service, (vii) description or content of the event (e.g., including images or a link to the event or event provider's website), and/or (viii) a time or a duration of time in which the offer will expire. The user data set 131 can correspond to a user identifier (or mobile device identifier of the user) and/or contact information (e.g., phone number, email address, etc.) of each user in the identified set of users.

In some implementations, as illustrated in FIG. 1B, the notification component 170 can generate the event notification 171 using at least some of the set of event information 133. Additionally, the notification component 170 can transmit the event notification 171 to the respective MCDs 190 of the identified set of users based on the user data set 131. In some examples, the event notification 171 (as well as other notifications described herein) can correspond to a text message, an application push notification associated with the client application 191, or an in-application message that is displayed in the user interface of the client application, or other messages that can be displayed by the operating system of the MCD 190 or the client application 191. In other examples, the event notification 171 can be an interactive notification that can include one or more selectable features or links (e.g., selecting the feature or link can launch or open the client application 191 and/or a website, on a browser application, associated with the event or the event provider).

Individual users of the set of users can view the event notification 171 on the respective MCDs 190 and decide whether or not that user would like to participate in the event (e.g., indicate attendance, reserve seats, buy tickets, etc.). For example, the event can correspond to a general admission concert, where the event provider has twenty available seats or spots. A first user of the set of users may decide that she wants to attend the event. The first user can operate the client application 191 (e.g., after viewing the event notification 171), which can display information about the event and the offer (e.g., price and/or price discount) in an event user interface, and specify that she wants to purchase four tickets by providing input on the user interface.

The client application 191 can generate and transmit an acceptance message 193 to system 100 in response to the first user accepts or requests a certain number of available seats for the event. The acceptance message 193 can indicate the first user's intent or interest in attending the event and can include a set of information, such as (i) the user's name, (ii) a user identifier, (iii) contact information, (iv) the event identifier and/or the event provider identifier, and/or (v) the number of requested or accepted seats for the event. In some examples, the acceptance message 193 can also include data that indicates to the system 100 whether the first user wants the system 100 to send a reminder to request a transport service or to request the transport service for the first user at a time before the start time of the event.

The facilitation service 130 can receive the acceptance message 193 from the first user's MCD 190, and subsequently, can perform one or more operations. For example, the facilitation service 130 can (i) associate the first user's profile with the event entry, and/or indicate, in the first user's profile, information about the event entry that the user has accepted or ordered, (ii) update the event entry by updating the number of available seat(s) or indicate specific seats, if any, that have been requested or ordered by the first user, (iii) update the event entry with the first user's information in connection with the seat(s), (iv) update the presentation or user interface of the event provider portal 151 via the presentation component 132 in connection with the updated event entry, respectively, (e.g., so that if the event provider is operating or viewing the user interface of the event provider portal 151, the user interface can be dynamically updated 135) and/or (v) transmit a notification and/or a set of data to the event provider device 150, such as an identifier and/or name of the first user, the number of requested seats for the event, contact information for the first user, and/or other information.

In some examples, the client application 191 can enable a user to browse or search for events. Event providers can generate event entries and enable information about those events to be surfaced to a plurality of users (e.g., a specific set of users). Depending on implementation, users can select events to receive notifications about and/or select events to attend.

Still further, in some examples, a payment method or payment profile can already be associated with the user's account (e.g., a debit or credit card number, a gift card, checking account, an online payment account, etc.) if the first user has an account with the system 100. In such examples, the system 100 can process the payment for the purchased tickets for the first user using the first user's specified or selected payment method on behalf of the event provider (e.g., via its own payment processing service or by communicating with a third-party payment processing system, not illustrated in FIG. 1B for purposes of simplicity). The system 100 can then credit or initiate a payment of the appropriate amount to an account associated with the event provider.

In some examples, the system 100 can also automatically associate the price discount with the first user's account and/or apply the discount (e.g., a credit or a percentage off discount) to the first user's transport service when it is completed. The system 100 can automatically associate the price discount with the first user's account and/or apply the discount, if the event provider had provided a price discount for a transport service in connection with the event. For example, an event provider may have specified (e.g., via the event provider portal 151) that a user who buys a ticket to the event provider's specified event will get fifty percent of the transport service paid for by the event provider, with a maximum cap of $15. The event provider may specify a location condition and/or a time condition so that the system 100 can apply the price discount only if the user gets dropped off within a predefined distance from the location of the event venue, for example, and/or during a certain window of time with respect to the start time of the event (e.g., between a time twenty minutes before the start time and/or ten minutes after the start time). In some implementations, the system 100 can automatically associate the price discount with the first user's account and/or apply the discount, provided that the parameters of that transport service satisfy one or more trip conditions associated with the event.

The facilitation service 130 can update the presentation or user interface of the event provider portal 151 when a user indicates that he/she wants to accept or order a seat(s) for the event. In some examples, the updated presentation or user interface of the event provider portal 151 can include content about which seats have been reserved or ordered and/or updated information about the users (e.g., the user name, contact information, etc.) via the event provider portal 151. The presentation can display the updated number of available seats for the event, if any are remaining, or indicate that all available seats have been filled. The presentation can also display other information about the fulfillment of the available seats, such as user information, the number of seats for the respective users, the amount of money pending, processed, or received, the amount of money owed to the system 100 for fulfilling a number of available seats, etc.

Still further, in some examples, the facilitation service 130 can also transmit one or more additional notifications to one or more of the identified set of users that received the initial event notification 171. In some examples, the event manage component 134 can monitor the number of available seats that have been taken or reserved by users. Additionally, the facilitation service 130 can cause the notification component 170 to transmit an addition notification, to those users who did not reserve or order any seats for the event. For example, the facilitation service 130 can transmit an additional notification to users who did not reserve or order any seats for the event if a certain number or a certain percentage of available seats have been taken or are remaining. In some examples, the additional notification can indicate that there are only a few (or a specified number) of available seats remaining for the event. The facilitation service 130 can provide an updated user data set 131 of only those users to the notification component 170 so that not all of the identified sets of users are again sent a notification. In some implementations, the facilitation service 130 can transmit an additional notification, to those users who did not reserve or order any seats for the event, informing them when there are no available seats left (e.g., the additional notification can include a message that says “Sorry you missed your chance for Event. We'll message you again next time!”). The facilitation service 130 can also transmit an additional notification to the event provider's device informing him/her that all available seats have been filled. In other examples, the facilitation service 130 can identify a new set of users and transmit a new event notification 171 to those users if a select few or none of the identified set of users accept or order a seat(s) to an event after a specified duration of time.

The facilitation service 130 can also enable the event provider to request additional operations to be performed via the system 100. According to some examples, an event provider can be an individual who is using the system 100 as a platform for organizing transport to a hosted party or get-together (e.g., a holiday party, a birthday party, a wedding, etc.). In such examples, the event provider can create an event via the event provider portal 151, and invite or notify a set of specified users about the event. For purposes of simplicity, the set of specified users can each have an account with the system 100. The event provider device 150 can transmit a set of event data 155 along with a set of user identifiers (e.g., names, phone numbers, and/or email addresses, etc.) to the facilitation service 130.

After the system 100 sends an event notification 171 to the MCDs 190 of the specified set of users and receives one or more acceptance messages 193 from at least one of the specified set of users, the presentation component 132 can update the presentation or user interface of the event provider portal 151. For example, the presentation component 132 can update the presentation of the user interface of the event portal 151 to include a set of features that indicates which users have been sent the event notification 171, which users have accepted the event, and in some examples, the statuses of the users (e.g., display a set of user data 157). In some examples, some or all of the users may have opted in to allow their friend or event provider to view their statuses and/or locations. In such examples, the system 100 can determine user data of at least some of the specified set of users by receiving data from the matching service 110, including the location of the user, whether the user has request a transport service, whether the user is on the way to the event location, how far the user is (by time and/or distance) from the event location, etc. In some examples, by viewing the user data 157, the event provider can decide that he/she wants the system 100 to perform one or more operations (e.g., transmit an impromptu notification to one or more users of the specified set of users). For example, the event provider can transmit a notification trigger 159 by selecting one or more selectable features to cause the system 100 to transmit an additional, dynamic notification about the event to one or more users (e.g., “You should request your transport service soon!” or “The event is going to start in one hour!”). The notification trigger(s) 159 can include data about the type of operation (e.g., a notification, a dis-invitation, a price credit or splitting of a fare, etc.), content (e.g., text or description), an event identifier and/or event provider identifier, and/or one or more user identifiers in connection with the notification, etc.

The system 100 can also include the matching service 110. The matching service 110 can arrange a transport service or a delivery service, for a user. The facilitation service 130 can communicate with the matching service 110 to cause the system 100 to transmit a trip notification 173 to a user who has accepted or ordered a seat(s) at the specified event in advance of the start time of the event. For example, a user may have opted in to receive a trip notification reminding the user to make a request for a transport service. For such individual users of the specified event, the facilitation service 130 can determine when to make a notification request 137 to the matching service 110 to generate a trip notification 173 for the user (note, in an alternative example, the facilitation service 130 can determine when to cause the notification component 170 to generate a trip notification 173).

In some examples, the facilitation service 130 can trigger the trip notification 173 to be sent to users at a predetermined time before the start time of the event (e.g., forty five minutes before the start time of the event). In other examples, the facilitation service 130 can determine when to trigger the trip notification 173 to be sent to individual users based on the event information, user-specific information (info 111, such as the current location of the user and/or user's MCD 190 received from the geo-location resource of the user's MCD 190, preferred or previously selected vehicle type) and information about the service providers of the system 100 (info 113, such as the estimated time of arrival to the current location of the user) determined by the matching service 110.

Additionally, the facilitation service 130 can determine when to trigger the trip notification 173 for an individual user. For example, the facilitation service 130 can determine when to trigger the trip notification 173 by (i) determining a current location of the user, (ii) determining a first estimated travel time for one of a set of candidate service providers to travel to the current location (e.g., an average or median estimated travel time for a set of candidate service providers to travel to the current location based on the locations of the candidate service providers, route information based on map data, and/or current traffic information), and (iii) determining a second estimated travel time from the current location to the event location (e.g., based on route information based on map data and/or current traffic information), and then by comparing an amount of time left before the event starts (e.g., the duration of time between the current time and the start time of the event) with the time it may take for the user to get to the event location (e.g., the sum of the first estimated travel time and the second estimated travel time). The time it takes for the user to get to the event location can also include an additional buffer time (e.g., a predetermined time to provide some flexibility, such as the time it may take for the user to get to the vehicle or the event location, the time it may take for the user to enter the vehicle or leave the vehicle, or to account for unpredicted traffic occurrences, etc.). The facilitation service 130 can perform these computations and comparisons periodically (e.g., every two minutes or every three minutes, etc.).

According to examples, based on the comparison, the facilitation service 130 can trigger the notification request 137 if the amount of time left before the event starts (e.g., forty five minutes) is equal to the time it takes for the user to get to the event location from the current location (e.g., forty five minutes). In other examples, based on the comparison, the facilitation service 130 can trigger the notification request 137 if the amount of time left before the event starts (e.g., forty five minutes) minus a predefined duration of time (such as the time it may take for the user to view the notification and make a trip request, such as ten minutes) (e.g., so a total of thirty minutes) is equal to the time it takes for the user to get to the event location from the current location (e.g., thirty five minutes). The predetermined time and the predefined duration of time can vary and can be user-configurable (e.g., by individual users or by an administrative user of the system 100). The system 100 can transmit the trip notification 173 to the individual users' MCDs 190 to remind the individual users to request a transport service to make it to the event on time (and/or to also reminder information about the event).

Individual users can operate their respective client application 191 to make a request for a transport service (e.g., a trip request 195) using the MCD 190. The respective client application 191 can generate a trip request 195 when a user requests a transport service using the MCD 190. The trip request 195 can include an identifier (ID) of the user, information of the pickup location (e.g., a current location of the user, or an address or a location data point, such as a latitude and longitude coordinate, etc.), information of the destination location, payment method information, and/or vehicle type information. According to some examples, if the user opens and/or interacts with the trip notification 173 (which opens or launches the client application 191) and then makes a request for a transport service, the trip request 195 can automatically include the event location as the destination location of the trip for the user. A request manage component 112 of the matching service 110 can process the request 195 by verifying the payment instrument of the user, and creating and storing a data entry (e.g., a trip entry) associated with the request 195, such as in the trips database 143.

A vehicle select component 114 of the matching service 110 can determine a pool of available candidate service providers/vehicles (e.g., corresponding to the specified vehicle type) based on the current service provider/vehicle state and/or location information from the service provider database 142. Additionally, the vehicle select component 114 can select a service provider to provide the transport service for the requesting user. For example, the vehicle select component 114 can access the service provider database 142, which stores updated or real-time information of the service providers' operating states and current locations. According to some examples, the service provider tracking component 120 can receive service provider data 183 from each of the service provider apps 181 of the service provider MCDs 180, e.g., periodically, such as an identifier of the service provider or the MCD 180, a current location of the service provider or the service provider MCD 180 (e.g., a location data point, such as a GPS coordinate), and/or the state of the service provider (e.g., whether the service provider is on duty, available, providing a trip already, etc.). The service provider tracking component 120 can continuously (or periodically) update the service providers' entries with the service provider data 183.

The matching service 110 can update the trip entry associated with the transport service (and/or the request 195) in the trips database 143 with information associated with the selected service provider. In some implementations the matching service 110 can update the trip entry once the vehicle select component 114 selects a service provider to provide the transport service. The trip entry can include the ID of the user, the ID of the service provider, information about the pickup location, information about the destination location, the vehicle type, information about the payment instrument of the user, price parameters associated with the trip, and/or price information, if any, associated with the specified event (e.g., a price amount or discount that may be applied to the trip in connection with the user accepting or ordering a seat(s) at the event).

The matching service 110 can transmit an invitation message 185 to the service provider application 181 of the selected service provider. The invitation message 185 can include information about the pickup location of the user as well as user information (e.g., a user name, a rating of the user, a photo, etc.). If the service provider chooses to provide the transport service, the service provider can accept the invitation via user input. The service provider application 181 can transmit an acceptance message 187 to the matching service 110. The matching service 110 can also transmit data to the user MCD 190 to provide a notification to the user that a service provider has been selected for the user. In some implementations the matching service 110 can provide an estimated time of arrival to the pickup location of the user. The notification can include information about the selected service provider to be displayed on a user interface of the client application 191 (e.g., the service provider's name, the vehicle model, color, image of the vehicle, service provider rating, etc.). In some examples, the matching service 110 can include or communicate with a routing or mapping component (e.g., a routing engine). In such examples, the matching service 110 can determine the estimated time of arrival of the selected service provider from the current location of the when it accepted the trip.

A trip monitor 116 component of the matching service 110 can track or monitor the location and/or status of the service provider as the service provider travels to the pickup location (and subsequently, as the service provider transports the user from the pickup location to the destination location). As described herein, the service provider application 181 can periodically provide service provider data 183 to the system 100. In some implementations, the trip monitor 116 component can periodically receive the location and/or status information of the service provider from the service provider tracking component 120, and/or periodically retrieve the location and/or status information of the service provider from the service provider database 142. The trip monitor 116 component (and/or the service provider tracking 120) can continue to receive service provider data 183 from the service provider application 181. For example, the trip component can continue to receive service provider data 183 when the state of the trip changes, when the transport service is initiated, and when the transport service is completed. The trip monitor 116 component can store the locations and/or status changes of the service provider application 181, as trip data 145 in the trip entry. For example, the trip monitor 116 component can store the locations and/or status changes as the service provider travels to the pickup location and subsequently, as the service provider transports the user from the pickup location to the destination location.

Still further, as described in some examples, the facilitation service 130 can communicate with the matching service 110 to provide real-time or close to real-time trip information 115 about users or users' trips to the event provider portal 151. The presentation component 132 can receive the trip information 115 from the matching service 110 to update the presentation. In other examples, the matching service 110 can provide the trip information 115 to the event provider device 150 via the provider interface 104. This can enable an event provider to (i) view user data in connection with a specified event on the user interface of the event provider portal 151 (e.g., the location of a user, whether the user has request a transport service, whether the user is on the way to the event location, how far the user is from the event location, etc.), and (ii) cause the system 100 to perform one or more operations with respect to one or more users.

Methodology

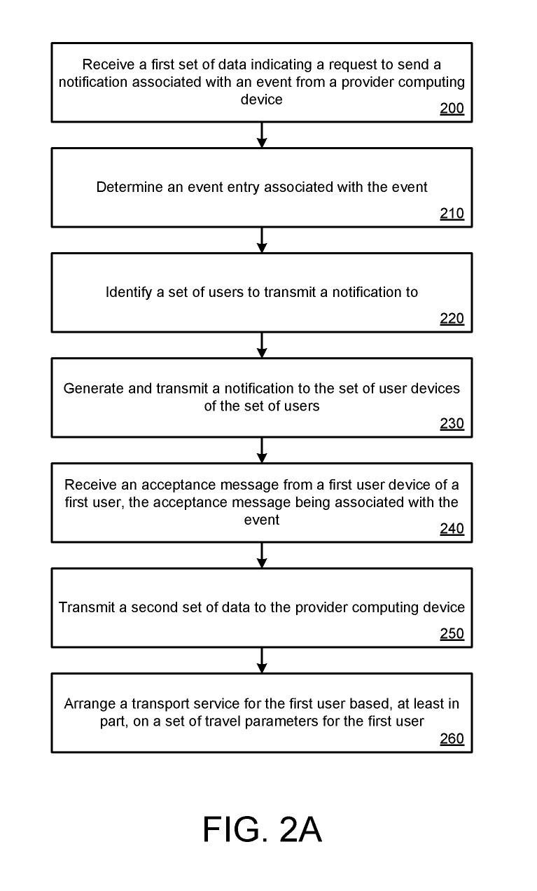

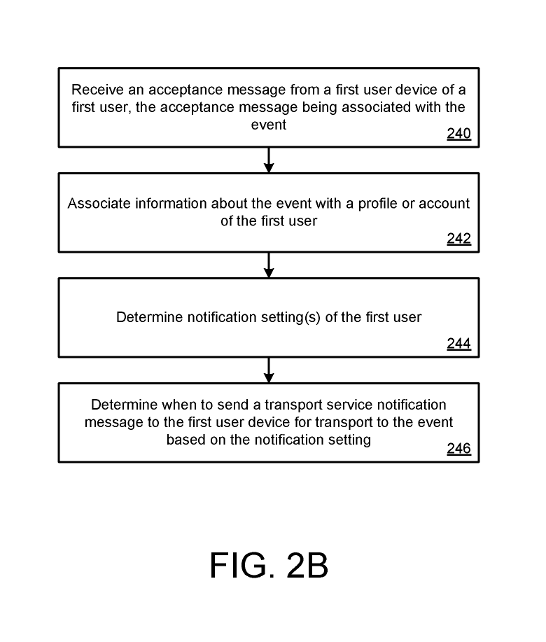

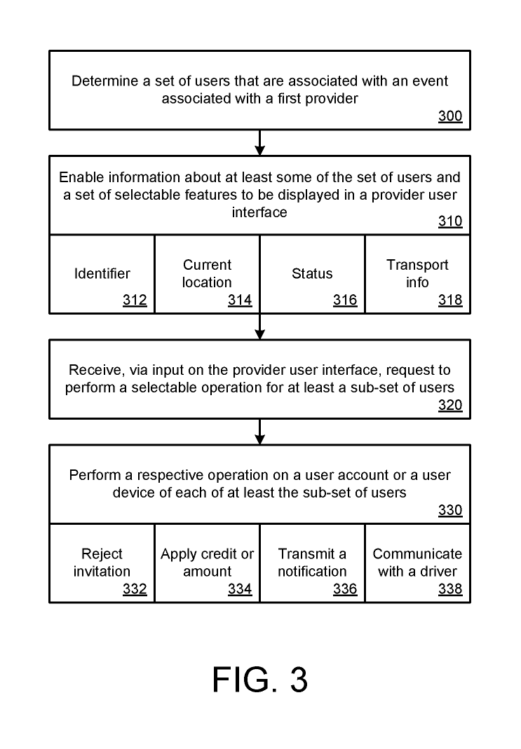

FIG. 2A illustrates an example method for facilitating user participation in events. FIG. 2B illustrates an example method for providing a service notification. FIG. 3 illustrates an example method of selectively performing operations for users of an event. Methods such as described by examples of FIGS. 2A, 2B, and 3 can be implemented using, for example, components described with examples of FIGS. 1A through 1B. Accordingly, references made to elements of FIGS. 1A through 1B are for purposes of illustrating a suitable element or component for performing a step or sub-step being described.

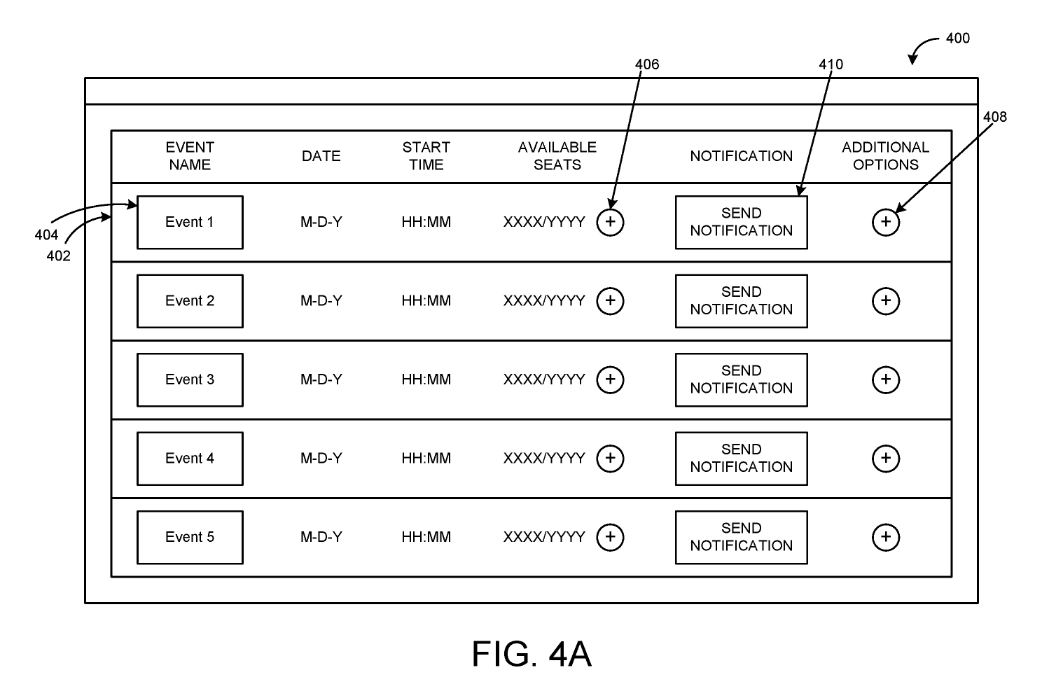

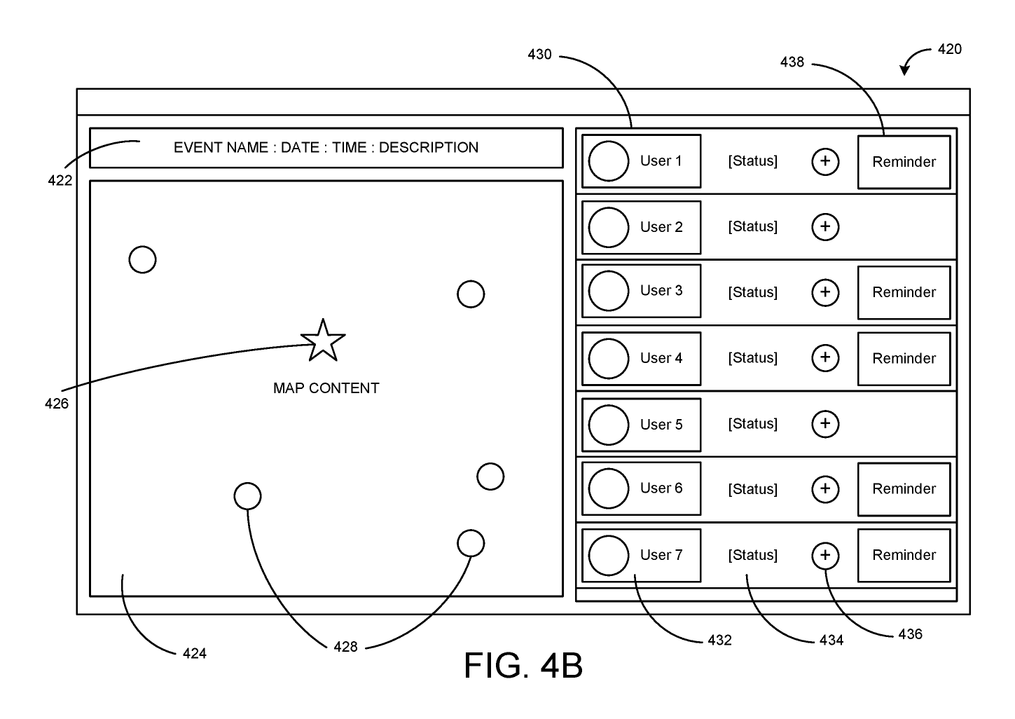

Referring to FIG. 2A, a service arrangement system 100 can enable event providers to dynamically inform users about availabilities at their events at various times and enable users to accept or order one or more available seats of an event through use of computing devices. According to some examples, the system 100 can provide an event provider portal 151 that is accessible by event providers to create, edit, and/or manage event entries by inputting event information for specific events. FIG. 4A, for example, an example user interface of an event provider dashboard that is accessible by the event provider via an event provider portal on an event provider device. The user interface 400 can present a plurality of entries 402 that each corresponds to an event that is operated or held by the event provider. In some implementations, the event provider may have created and stored one or more event entries with the system 100 and/or may have enabled the system 100 to obtain data about the event entries from a reservation or inventory program or service used by the event provider (e.g., via an API).

Each entry 402 can include one or more selectable features and information about the particular event. For example, an entry 402 can include the name of the event (“Event 2”), the date, the start time, the number of available seats and/or total seats (or occupied seats), and other features. The event entry 402 can include a selectable feature 404 that, when selected by the event provider, causes the event provider portal 151 to display additional information about the event and/or enable the event provider to perform additional operations (e.g., modify information, delete the entry, view details, etc.), by displaying a pop-up window or another user interface. The event entry 402 can also include a selectable feature 406 that, when selected by the event provider, causes the event provider portal 151 to display details about the available seats and/or occupied seats, and/or another selectable feature 408 that, when selected, causes the event provider portal 151 to display other options that the event provider can perform or request the system 100 to do. The user interface 400 can include other features or display panels, such as an add new entry feature to create a new event entry, but are not illustrated in FIG. 4A for purposes of simplicity).

The user interface 400 can also include a notification feature 410 that enables the event provider to make a request to the system 100 to generate and transmit a notification about the corresponding event to a set of users. While the example user interface 400 of FIG. 4A illustrates the each entry 402 having a corresponding notification feature 410, in other examples, the user interface 400 can include a single notification feature 410 (e.g., the event provider can select one or more entries 402 via a check box, for example, and then select the single notification feature 410).

Referring back to FIG. 2A, the system 100 can receive a first set of data (e.g., a first in-app notification, message, etc.) indicating a request to send a notification associated with an event from the event provider device 150 (200). According to some examples, the first notification can include at least an identifier associated with the event and/or an identifier associated with the event provider. For example, referring to FIG. 4A, the event provider may want to notify a set of users that a particular event (e.g., Event 1) has a number of available seats remaining. The event provider can have the flexibility to do this at any time before the event, such as a few hours in advance of the event start time or even a few minutes before, or even after the event starts (and there are still available seats). The event provider can select the notification feature 410 of Event 1, which can cause the event provider portal 151 to transmit the first notification to the system 100. Still further, in some examples, when the notification feature 410 is selected, the event provider portal 151 can determine a set of notification parameters or settings that specify the notification that is sent to users (e.g., notification content, price for the seats, pricing discounts for transport services, a duration to time to accept or order a seat(s), when the time expires, etc.). In some implementations, the set of notification parameters can be predefined by the event provider (e.g., as default or stored parameters) or the event provider can provide the set of notification parameters after selecting the notification feature 410. In other implementations, the event provider portal 151 can enable the event provider to schedule a notification to be sent to a set of users if there are available seats for an event (e.g., an hour before the event start time).

The system 100 can determine an event entry associated with the event (e.g., based on the event identifier and/or the provider identifier) (210), in response to receiving the first notification. Additionally, the system 100 can identify a set of user to transmit an event notification to (220), based on at least some of the event information of the event entry. In some examples, the system 100 can identify the set of users based on a determined a geographic region from the data of the event entry (e.g., such as based on the location of the event). In such examples, the system 100 can access a user database to search for user accounts that (i) include one or more user-specified locations that is located within the geographic region (e.g., a home address, a work address, a favorite location, etc.), or (ii) include data about recently visited locations within the geographic region (e.g., locations being associated with a time within the past predefined duration of time). The recently visited locations can correspond to the locations of the users when the users interacted with the client applications 191 (e.g., opened or provided input on the client applications 191) or to the locations of the users locations determined from trip data of requested and/or completed trips (e.g., start locations and/or destination locations). In other examples, the system 100 can identify users that are located within the geographic region, based on received information about the current location of users from the MCDs 190 of the users.

The system 100 can generate an event notification using some of the event information (and/or in some examples, based on the set of notification parameters) and transmit the event notification to the identified set of users' MCDs 190 (230). The event notification or message about the event can include at least a name or description of the event (and/or the name of the event provider), a start time of the event (and/or the date), and a number of available seats for the event. In some implementations, the event notification can include graphic content, location information for the event, pricing information for the seats, price discounts for transport services, etc. In other implementations the event notification can be an interactive notification that can enable a user to accept or order a number of seats and/or view additional information about the event. In some examples, the event notification can correspond to a text message or an application-based notification (e.g., one that can be displayed outside the client application 191). In such examples, the event notification can include a link or selectable feature that can enable a user to cause the MCD 190 to display content on the MCD 190 (e.g., by opening or launching the client application 191 to an active state and displaying the content in the client application 191).

One or more users, such as a first user, of the identified set of users can view the notification and decide whether or not he/she would like to participate or attend the event. The first user can operate the client application 191, for example, to indicate that she would like to reserve or order a number of available seats to the event. The client application 191 can generate and transmit an acceptance message to the system 100 in response to user input on the client application 191. The system 100 can receive the acceptance message from the user MCD 190 of the first user over one or more network(s) 160, which indicates the first user's interest in attending the event and includes data about the number of requested seats for the event as specified by the first user (240). In response, the system 100 can process the acceptance message by performing one or more operations, according to various examples.

For example, the system 100 can update the event entry with information associated with the first user and/or with data included in the acceptance message. The system 100 can also inform the event provider regarding the first user's acceptance by updating the user interface of the provider portal (e.g., update the number of available seats or occupied seats for the event, provide user information associated with the first user, etc.). The system 100 can inform the event provider by transmitting a second set of data (e.g., a second in-app notification, message, etc.) associated with the event to the event provider device 150, e.g., as a notification (250), and/or by updating the presentation or user interface of the event provider portal 151 accessible on the event provider device 150. The second set of data can include an identifier of the first user, the number of requested seats by the first user, the event identifier or information, time when the first user accepted, and/or other information associated with the first user and/or the event.

Still further, as an addition or an alternative to the method described in FIG. 2A, the system 100 can perform one or more other steps, such as described in FIG. 2B, after receiving the acceptance message from the first user device. For example, the system 100 can associate information about the event with a profile or account of the first user, and/or update the event entry with information associated with the first user (242). The system 100 can also determine one or more notification settings of the first user, such as whether the first user wants to receive a notification reminder about requesting a transport service (also referred to herein as a transport service notification), when the first user wants to receive a notification reminder, etc. (244). A notification setting can be a default setting or be a user-specified setting. In some examples, the system 100 can automatically notify the user by transmitting a notification reminder to the user device 190 of the first user at a predetermined duration of time after receiving the acceptance message, at a predetermined duration of time before the start time of the event, or at a dynamically determined time based on the current location of the first user or specified pickup location, the event location, the event start time, and/or determined estimated travel times. The system 100 can determine when to send a transport service notification to the user device 190 of the first user based on the notification setting (246).

The first user can operate the client application 191 to make a request for a transport service. The first user can make the request at any time using the client application 191, such as before or after receiving the transport service notification, or regardless of whether the first user received the transport service notification. In some examples, if the first user received the transport service notification and selected the notification to launch or open the client application 191, the client application 191 can automatically specify one or more travel parameters for the transport service (e.g., specify the destination location as the event location), and/or automatically make the request for the transport service with the specified travel parameter(s) (e.g., so that no additional input is required by the first user). The system 100 can receive the request for the transport service, process the request and determine the set of travel parameters (e.g., pickup location, destination location, vehicle type, etc.), and referring back to FIG. 2A, arrange the transport service for the first user based, at least in part, on the set of travel parameters (260). The system 100 can determine the amount the first user has to pay once the transport service for the first user is completed. The amount can be based on the time and/or distance traveled, the current price, any fees or base fares, tolls, and/or any applicable credits or discounts provided by the event provider, if any, as a result of the first user accepting one or more seats and satisfying one or more trip conditions.

In some examples, the system 100 can update the destination location of a transport service request if the transport service request had already initiated (e.g., the first user is in a service provider vehicle and traveling to a destination) when the first user received the event notification, and accepted one or more seats for the event. For example, depending on the current time and the start time of the event, the system 100 can provide the first user with an option to update the destination of the trip from the current destination to the event location if the first user accepts or orders a seat(s) at the event and the event is starting shortly (e.g., starting within a predefined duration of time). The system 100 can update the service provider application 181 with the new destination for the event location in response to the first user accepting or ordering seat(s) at the event.

Referring to FIG. 3, the system 100 can also enable event providers to perform other operations (or request the system 100 to perform other operations) in connection with an event. According to some examples, an event provider can be an event planner, an individual having a party, etc. Additionally, in such examples, users may correspond to individuals who personally know the event provider (e.g., are friends, are personal guests, etc.) or have asked to receive invitations to certain events (e.g., exclusive events, parties, etc.). Moreover, in such examples, the system 100 can determine a set of users that are associated with that event (300), for a particular event associated with a first event provider. The set of users may have accepted invitations or requested available seats for the event, such as described in examples described in FIGS. 1 through 2B.

The system 100 can provide an event provider portal 151 that is accessible by the first event provider to (i) create, edit, and/or manage event entries, (ii) view information about users that are associated with the event, and/or (iii) request user-specific operations. The system 100 can enable information about at least some of the set of users and a set of selectable features to be displayed in a provider user interface (310). The information can include a name or identifier of a user (312), a current location of the user (314), a status of the user (316), transport information for the user (318), and/or other information. FIG. 4B, for example, illustrates an example user interface 420 of an event provider dashboard that includes map content. In some implementations, the event provider dashboard can be accessible by the first event provider via a provider portal 151 on an event provider device 150. The user interface 420 shows details about a particular event (e.g., identified in panel or section 422) as well as up to date information about those users that are associated with the event (e.g., and/or have opted in to share their information with the first event provider).

As illustrated in FIG. 4B, the user interface 420 can include a map portion 424 that includes map content of an area surrounding the event location 426. A set of graphic icons 428 can be presented on the map content to indicate the location of a set of users. Each graphic icon 428 can be different to represent a different user (e.g., using a letter, number, image, etc.), or alternatively, can be identical. The user interface 420 can also include a user information section 430, which includes one or more user entries for the one or more users that are associated (or participating) in the event. In some examples, the user entry can include a selectable user identifier 432 (e.g., along with a name and/or photograph, or contact information) that can be selected by the first event provider to view additional information about the user, a status 434 of the user that dynamically updates based on user data and/or transport service data, a selectable feature 436 to enable the first event provider to request one or more selectable operations, and a reminder feature 438 to enable the first event provider to request the system 100 to transmit a notification about the event (e.g., reminder that the event starts soon) to the user.

The system 100 can periodically determine the current locations of the users and/or statuses of the users (including the status of the transport service). Additionally, the system 100 can update the map portion 424 and/or the user information section 430 accordingly. For example, the status 434 of a user can be updated from “invited” to “accepted,” or “requested” to “on trip,” or updated to “checked-in” or “at event.” The graphic icons 428 can also be updated as the current locations of the users are updated, thereby reflecting the movement of the users on the map content.

Referring back to FIG. 3, the system 100 can receive, via input from the provider user interface, a request to perform an operation for at least a sub-set of users (320). In response, the system 100 can perform a respective operation on a user account or a user device of each of at least the sub-set of users (330). In some implementations, the system 100 can provide the first event provider with a plurality of different selectable operations. The operations can include, for example, dis-inviting or disassociating a user(s) from the event (e.g., cancel the invitation or reject the invitation) (332), applying a price discount or credit for a transport service to the user's account or modifying the amount for the price discount to be paid by the first event provider (e.g., the first event provider pays a portion of the user's transport service to the event), or splitting the total fare for the user's transport service to the event (334), transmitting a notification to a user(s) (336), or communicating with a service provider(s) that is transporting a user(s) (338).

Hardware Diagrams

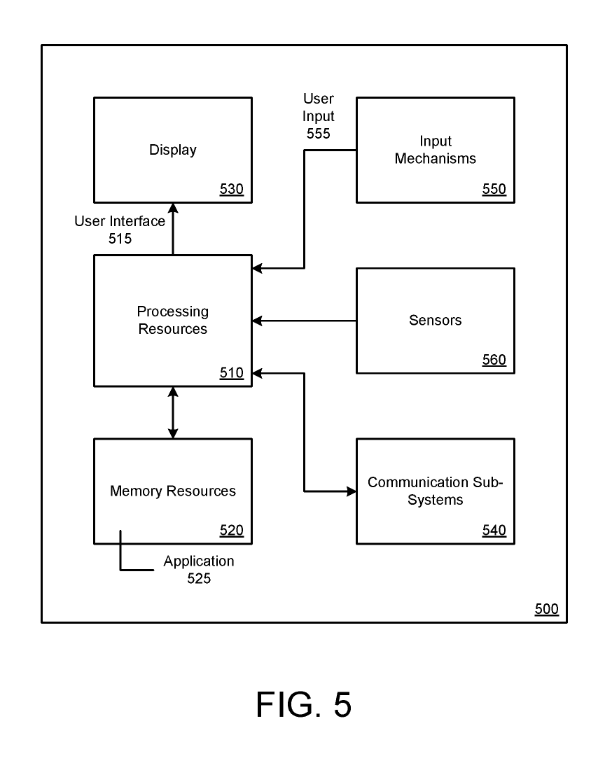

FIG. 5 is a block diagram that illustrates a computing device upon which embodiments described herein may be implemented. In some examples, a computing device 500 may correspond to a mobile computing device, such as a cellular device that is capable of telephony, messaging, and data services. The computing device 500 can correspond to a provider device, a user MCD (e.g., user MCD 190), or a service provider MCD (e.g., service provider MCD 180). Examples of such devices include smartphones, handsets or tablet devices for cellular carriers. The computing device 500 includes a processing resources 510, memory resources 520, a display 530 (e.g., such as a touch-sensitive display device), one or more communication sub-systems 540 (including wireless communication sub-systems), input mechanisms 550 (e.g., an input mechanism can include or be part of the touch-sensitive display device), and one or more sensors 560, including a location detection mechanism (e.g., GPS receiver). In some examples, at least one of the communication sub-systems 540 sends and receives cellular data over data channels and voice channels. The communications sub-systems 540 can include a cellular transceiver and one or more short-range wireless transceivers. The processing resources 510 can receive communications from the service arrangement system, for example, via the communications sub-systems 540.

In the example of FIG. 5, the computing device 500 can correspond to a device that is operated by a user of the network service, such as an event provider. The processing resource 510 can provide a variety of content to the display 530 by executing instructions stored in the memory resources 520. The memory resources 520 can store instructions corresponding to a provider client application 525 (or in another example, instructions corresponding to a browser that displays content via a web page), for example, and other data associated with the event provider in connection with the network service. For example, the processing resource 510 is configured with software and/or other logic to perform one or more processes, steps, and other functions described with implementations, such as described by FIGS. 1A through 4B, and elsewhere in the application. In particular, the processing resource 510 can execute instructions and data stored in the memory resources 520 (and/or from data received via the communication sub-systems 540) in order to display a user interface(s) 515 of the provider client application 525 (or the browser with the appropriate user interfaces in the web page). An event provider can interact with the user interfaces 515, such as the user interfaces illustrated in the examples of FIGS. 4A and 4B, to create, edit, manage, etc., event entries, and request the network service to transmit notifications to users of the network service by providing user input 555 via the input mechanisms 550. The processing resource 510 can execute instructions to cause the computing device 500 to transmit and/or receive data in connection with facilitating user participation in events, as described by FIGS. 1A through 4B.

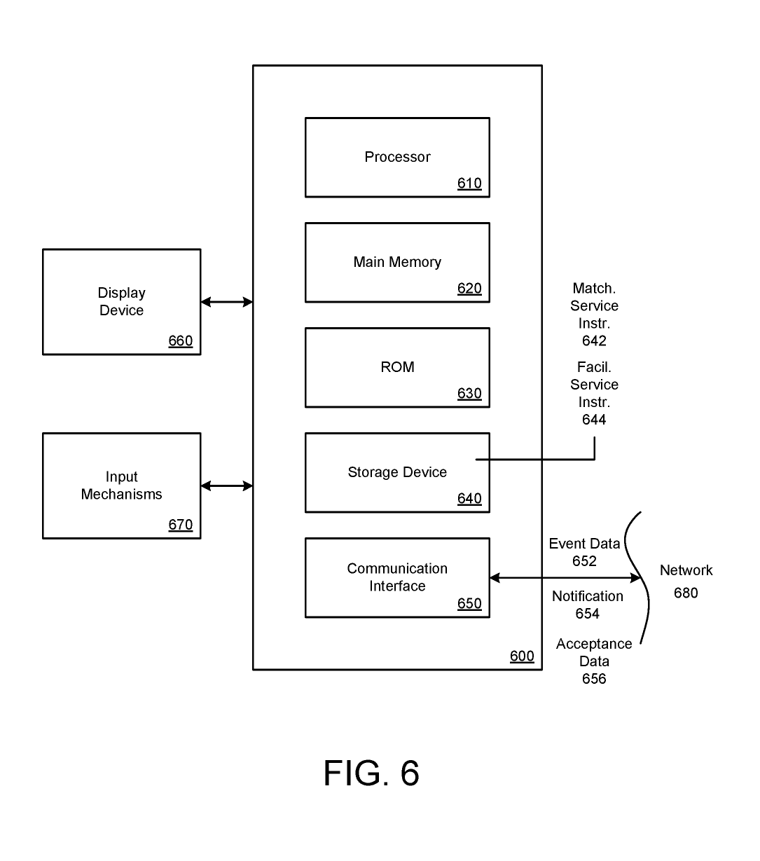

FIG. 6 is a block diagram that illustrates a computer system upon which examples described herein may be implemented. For example, in the context of FIGS. 1A and 1B, the service arrangement system 100 may be implemented using a computer system such as described by FIG. 6. The service arrangement system 190 may also be implemented using a combination of multiple computer systems as described by FIG. 6. In another example, in the context of FIGS. 1A and 1B, the event provider device 150 may correspond to a computer system such as described by FIG. 6.

For purpose of simplicity, the computer system 600 is described in connection with the service arrangement system 100. In one implementation, the computer system 600 includes processing resources, such as one or more processors 610, a main memory 620, a read-only memory (ROM) 630, a storage device 640, and a communication interface 650. The computer system 600 includes at least one processor 610 for processing information and the main memory 620, such as a random access memory (RAM) or other dynamic storage device, for storing information and instructions to be executed by the processor 610. The main memory 620 also may be used for storing temporary variables or other intermediate information during execution of instructions to be executed by the processor 610. The computer system 600 may also include the ROM 630 or other static storage device for storing static information and instructions for the processor 610. The storage device 640, such as a magnetic disk or optical disk, is provided for storing information and instructions.

For example, the storage device 640 can correspond to a computer-readable medium that stores matching service instructions 642 and facilitation service instructions 644 for performing operations discussed with respect to FIGS. 1A through 5. In such examples, the computer system 600 can provide a user interface for event providers to create, edit, modify, or delete information associated with events and receive, from an event provider, a set of data indicating a request to send a notification associated with an event (e.g., event data 652). The computer system 600, through execution of the facilitation service instructions 644, for example, can determine the event, identify a set of users to receive an event notification, generate and transmit the event notification (e.g., notification 654), and receive an acceptance message (e.g., acceptance data 656) from one or more users that want to participate in the event. In addition, the storage device 640 can include other data, such as data stored in the plurality of databases, such as described in FIG. 1B. As an addition or an alternative, databases can be stored in another data store that is accessible by the computer system 600.

The communication interface 650 can enable the computer system 600 to communicate with one or more networks 680 (e.g., cellular network) through use of the network link (wirelessly or using a wire). Using the network link, the computer system 600 can communicate with a plurality of devices, such as the mobile computing devices of the riders or users and devices operated by event providers. The computer system 600 can also include a display device 660, such as a cathode ray tube (CRT), an LCD monitor, or a television set, for example, for displaying graphics and information to a user. An input mechanism 670, such as a keyboard that includes alphanumeric keys and other keys, can be coupled to the computer system 600 for communicating information and command selections to the processor 610. Other non-limiting, illustrative examples of the input mechanisms 670 include a mouse, a trackball, touch-sensitive screen, or cursor direction keys for communicating direction information and command selections to the processor 610 and for controlling cursor movement on the display 660.

Examples described herein are related to the use of the computer system 600 for implementing the techniques described herein. According to some examples, those techniques are performed by the computer system 600 in response to the processor 610 executing one or more sequences of one or more instructions contained in the main memory 620. Such instructions may be read into the main memory 620 from another machine-readable medium, such as the storage device 640. Execution of the sequences of instructions contained in the main memory 620 causes the processor 610 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is being claimed is:

1. A method of facilitating user participation of an event, the method being performed by one or more processors of a computing system and comprising:
receiving, over one or more networks at the computing system from a provider computing device operated by or associated with an event provider, a first set of data indicating a request and an event identifier;
determining, by the computing system, an event entry based on the event identifier;
determining, by the computing system, a geographic region based on data from the event entry;
selecting, by the computing system accessing a user database, a set of users based at least in part on the geographic region;
sending, by the computing system, a first notification for a set of users, the first notification including information that is based on each of a start time of the event and a number of available seats for the event;
receiving, at the computing system from a first user computing device, a response to the first notification, the response indicating a number of seats for the event to associate with a first user;
sending, from the computing system to the event provider computing device, a second notification that includes (i) an identifier of the first user, and (ii) the number of requested seats for the event specified by the first user; and
arranging a transport service for the first user based, at least in part, on a set of travel parameters for the first user, the set of travel parameters including a pickup location and a destination location corresponding to a location of the event, wherein arranging the transport service includes (i) selecting a service provider to provide the transport service, and (ii) sending, to a computing device of the service provider, an invitation to provide the transport service.

2. The method of claim 1, wherein selecting the set of users includes searching the user database for user profiles that include one or more user-specified locations that is located within the geographic region.

3. The method of claim 1, wherein selecting the set of users includes searching the user database for users that are determined to be located within the geographic region within a past predefined duration of time.

4. The method of claim 3, wherein searching the user database includes determining the users that have opened or launched a client application on the respective user computing devices within the geographic region within the past predefined duration of time.

5. The method of claim 3, wherein searching the user database further includes determining the users that have further indicated, in the respective user profiles, an event category or event type that corresponds to a category or type associated with event entry.

6. The method of claim 1, further comprising:
before arranging the transport service, determining when to send a transport service notification to the first user computing device based, at least in part, on the start time; and
transmitting, from the computing system, the transport service notification to the first user computing device.

7. The method of claim 6, wherein determining when to send the transport service notification includes (i) determining a current location of the first user computing device, (ii) determining a first estimated travel time for one of a set of candidate service providers to travel to the current location of the first user computing device, (iii) determining a second estimated travel time from the current location of the first user computing device to the destination location, and (iv) comparing a duration of time between a current time and the start time with a sum of the first estimated travel time, the second estimated travel time, and a predetermined time.

8. The method of claim 1, further comprising:
before arranging the transport service, receiving, from the first user computing device, a request for the transport service, the request including the set of travel parameters.

9. The method of claim 1, wherein the event corresponds to a concert, a movie, a show, a sporting event, a tour, a party, a pop-up store event, a hotel reservation, a flight reservation, or a restaurant reservation.

10. A non-transitory computer-readable medium storing instructions that, when executed by one or more processors of a computing system, cause the computing system to:
receive, over one or more networks at the computing system from a provider computing device operated by or associated with an event provider, a first set of data indicating a request and an event identifier;
determine, at the computing system, an event entry based on the event identifier;
determine, at the computing system, a geographic region based on data from the event entry;
select, by the computing system accessing a user database, a set of users based at least in part on the geographic region;
send, at the computing system, a first notification for a set of users, the first notification including information about the event, a start time of the event and a number of available seats for the event;
receive, at the computing system from a first user computing device, a response to the first notification, the response indicating a number of requested seats for the event;
send, from the computing system to the event provider computing device, a second notification that includes (i) an identifier of the first user, and (ii) the number of requested seats for the event specified by the first user; and
arrange a transport service for the first user based, at least in part, on a set of travel parameters for the first user, the set of travel parameters including a pickup location and a destination location corresponding to a location of the event, wherein arranging the transport service includes (i) selecting a service provider to provide the transport service, and (ii) send, to a computing device of the service provider, an invitation to provide the transport service.

11. The non-transitory computer-readable medium of claim 10, wherein the instructions cause the computing system to select the set of users by searching the user database for user profiles that include one or more user-specified locations that is located within the geographic region.

12. The non-transitory computer-readable medium of claim 10, wherein the instructions cause the computing system to select the set of users by searching the user database for users that are determined to be located within the geographic region within a past predefined duration of time.

13. The non-transitory computer-readable medium of claim 12, wherein the instructions cause the computing system to search the user database by determining the users that have opened or launched a client application on the respective user computing devices within the geographic region within the past predefined duration of time.

14. The non-transitory computer-readable medium of claim 12, wherein the instructions further cause the computing system to search the user database by determining the users that have further indicated, in the respective user profiles an event category or event type that corresponds to a category or type associated with the event entry.

15. The non-transitory computer-readable medium of claim 10, wherein the instructions, when executed by the one or more processors, further cause the computing system to:
before arranging the transport service, determine when to send a transport service notification to the first user computing device based, at least in part, on the start time; and
transmit, from the computing system, the transport service notification to the first user computing device.

16. The non-transitory computer-readable medium of claim 16, wherein the instructions cause the computing system to determine when to send the transport service notification by (i) determining a current location of the first user computing device, (ii) determining a first estimated travel time for one of a set of candidate service providers to travel to the current location of the first user computing device, (iii) determining a second estimated travel time from the current location of the first user computing device to the destination location, and (iv) comparing a duration of time between a current time and the start time with a sum of the first estimated travel time, the second estimated travel time, and a predetermined time.

17. The non-transitory computer-readable medium of claim 10, wherein the instructions, when executed by the one or more processors, further cause the computing system to:
before arranging the transport service, receive, from the first user computing device, a request for the transport service, the request including the set of travel parameters.

18. A computing system, comprising:
one or more network interfaces;
one or more processors coupled to the network interfaces; and
one or more memory resources coupled to the one or more processors and storing a set of instructions that, when executed by the one or more processors of a system, cause the computing system to:
receive, over one or more networks at the computing system from a provider computing device operated by or associated with an event provider, a first set of data indicating a request to send a notification data associated with an event, the first set of data including at at least an identifier associated with the event;
determine, at the computing system, an event entry based on the event identifier;
determine, at the computing system, a geographic region based on data from the event entry;
select, by the computing system accessing a user database, a set of users based at least in part on the geographic region;
send, at the computing system, a first notification for a set of users, the first notification including information about the event, a start time of the event and a number of available seats for the event;
receive, at the computing system from a first user computing device, a response to the first notification, the response indicating a number of requested seats for the event;
send, from the computing system to the event provider computing device, a second notification that includes (i) an identifier of the first user, and (ii) the number of requested seats for the event specified by the first user; and
arrange a transport service for the first user based, at least in part, on a set of travel parameters for the first user, the set of travel parameters including a pickup location and a destination location corresponding to a location of the event, wherein arranging the transport service includes (i) selecting a service provider to provide the transport service, and (ii) send, to a computing device of the service provider, an invitation to provide the transport service.

19. The computing system of claim 18, wherein the instructions cause the computing system to select the set of users by searching the user database for user profiles that include one or more user-specified locations that is located within the geographic region.

20. The computing of claim 18, wherein the instructions cause the computing system to select the set of users by searching the user database for users that are determined to be located within the geographic region within a past predefined duration of time.
